(19) United States
(12) Patent Application Publication
(10) Pub. No.: US 2018/0110029 A1
(43) Pub. Date: Apr. 19, 2018

(54) COMMUNICATION METHOD AND APPARATUS BASED ON ACCESS NETWORK PAGING AND CORE NETWORK PAGING

(71) Applicant: Electronics and Telecommunications Research Institute, Daejeon (KR)

(72) Inventors: Dongmyoung KIM, Sejong-si (KR); Myung Ki SHIN, Seoul (KR); Byungjun AHN, Daejeon (KR); Seung-Ik LEE, Daejeon (KR)

(73) Assignee: Electronics and Telecommunications Research Institute, Daejeon (KR)

(21) Appl. No.: 15/730,930

(22) Filed: Oct. 12, 2017

(30) Foreign Application Priority Data
Oct. 17, 2016 (KR) 10-2016-0134659
Sep. 6, 2017 (KR) 10-2017-0113874

(51) Int. Cl. H04W 68/12; H04W 68/02; H04W 76/04

(52) U.S. Cl. CPC H04W 68/12; H04W 68/005; H04W 76/046; H04W 68/02

(57) ABSTRACT

Provided is a communication method and apparatus based on access network paging and core network paging. A communication method performed by an anchor radio access network (RAN) receives a signaling message or a data packet for a user equipment (UE) from a core network, triggers paging for the UE, and transmits a paging request to the core network in response to a failure of the paging. The core network is configured to transmit a core network (CN) assisted paging request message to a new RAN within a determined target paging area in response to the paging request, and the new RAN is configured to perform the paging for the UE based on the CN assisted paging request message.

### CROSS-REFERENCE TO RELATED APPLICATION(S)

This application claims the priority benefit of Korean Patent Application No. 10-2016-0134659 filed on Oct. 17, 2016, and Korean Patent Application No. 10-2017-0113874 filed on Sep. 6, 2017 in the Korean Intellectual Property Office, the disclosures of which are incorporated herein by reference for all purposes.

### BACKGROUND

### 1. Field

One or more example embodiments relate to a communication method and apparatus based on access network paging and core network paging, and more particularly, to a method and apparatus that may perform communication through core network paging when a user equipment (UE) does not respond due to a failure of access network paging.

### 2. Description of Related Art

Long term evolution (LTE) defines that, if a terminal is in an inactive state, for example, an RRC_IDLE state, within a base station, the terminal is inactivated, for example, ECM_IDLE, even in a core network, and if the terminal is in an active state, for example, an RRC_CONNECTED state, within the base station, the terminal is activated, for example, ECM_CONNECTED, even in the core network. Accordingly, LTE is in a unit structure in which the core network requests paging if the terminal is inactivated.

On the contrary, 5th generation (5G) is designed such that, although a terminal is in an inactivate state within a base station, the terminal is activated in a core network and immediately transfers a packet to the base station without performing paging. Here, if paging of an access network unit initiated by the base station is used, the packet may be immediately transferred to an access network. Accordingly, if the terminal is out of a packet transfer range and it is not recognized at the core network, a packet loss may occur.

### SUMMARY

At least one example embodiment provides a communication method and apparatus that may request a core network for assistance if paging of an access network unit is tried and fails, and may retry paging of a core network unit, thereby effectively preventing a packet loss and a service connection failure occurring when using the paging of the access network unit.

At least one example embodiment also provides a communication method and apparatus that may optimize use of system and terminal resources by applying an optimized paging scheme based on a characteristic of a terminal and a network environment.

According to an aspect of at least one example embodiment, there is provided a communication method performed by an anchor radio access network (RAN), the method including receiving a signaling message or a data packet for a user equipment (UE) from a core network; triggering paging for the UE; and transmitting a paging request to the core network in response to a failure of the paging. The core network is configured to transmit a core network (CN) assisted paging request message to a new RAN within a determined target paging area in response to the paging request, and the new RAN is configured to perform the paging for the UE based on the CN assisted paging request message.

When the UE responds to the paging of the new RAN, NG2 and NG3 connections for the UE may be reestablished between the new RAN and the core network.

The UE may be configured to return from an RRC_INACTIVE state or an RRC_IDLE state to an RRC_CONNECTED state when the UE responds to the paging of the new RAN.

The communication method may further include forwarding at least one of the signaling message, the data packet, and context information to the new RAN when the UE responds to the paging of the new RAN.

The paging request may include RAN paging area information associated with the triggered paging and last activated cell information.

The communication method may further include buffering the signaling message or the data packet in response to a failure of the triggered paging.

The receiving of the signaling message or the data packet may include receiving the signaling message from a control plane (CP) function of the core network or receiving the data packet from a user plane (UP) function of the core network.

According to an aspect of at least one example embodiment, there is provided a communication method performed by a core network, the method including transmitting a signaling message or a data packet for a UE to an anchor RAN; receiving a paging request from the anchor RAN in response to a failure of paging of the RAN for the UE; and transmitting a CN assisted paging request message to a new RAN within a determined target paging area in response to the paging request. The new RAN is configured to perform the paging for the UE based on the CN assisted paging request message.

When the UE responds to the paging of the new RAN, NG2 and NG3 connections for the UE may be reestablished between the new RAN and the core network.

The UE may be configured to return from an RRC_INACTIVE state or an RRC_IDLE state to an RRC_CONNECTED state when the UE responds to the paging of the new RAN.

The anchor RAN may be configured to forward at least one of the signaling message, the data packet, and context information to the new RAN when the UE responds to the paging of the new RAN.

The paging request may include RAN paging area information associated with the paging of the anchor RAN and last activated cell information.

The signaling message or the data packet may be buffered at the anchor RAN in response to a failure of the paging of the anchor RAN.

The transmitting of the signaling message or the data packet may include transmitting the signaling message to the anchor RAN from a CP function of the core network or transmitting the data packet to the anchor RAN from a UP function of the core network.

According to an aspect of at least one example embodiment, there is provided a communication apparatus that communicates with a UE and a core network, the communication apparatus including a processor; and a memory configured to store at least one instruction executable by the processor. The processor is configured to receive a signaling message or a data packet from the core network in response to an execution of the at least one instruction at the processor, and to trigger paging for the UE, and to transmit a paging request to the core network in response to a failure of the paging, the core network is configured to transmit a core network (CN) assisted paging request message to a new RAN within a determined target paging area in response to the paging request, and the new RAN is configured to perform the paging for the UE based on the CN assisted paging request message.

When the UE responds to the paging of the new RAN, NG2 and NG3 connections for the UE may be reestablished between the new RAN and the core network.

The processor may be configured to forward at least one of the signaling message, the data packet, and context information to the new RAN when the UE responds to the paging of the new RAN.

The paging request may include RAN paging area information associated with the triggered paging and last activated cell information.

The processor may be configured to buffer the signaling message or the data packet in response to a failure of the triggered paging.

The processor may be configured to receive the signaling message from a CP function of the core network or to receive the data packet from a UP function of the core network.

According to example embodiments, if paging of an access network unit is tried and fails, it is possible to requesting a core network for assistance and to retry paging of a core network unit. In this manner, it is possible to effectively prevent a packet loss and a service connection failure occurring when using paging of the access network unit.

According to example embodiments, it is possible to optimize use of system and terminal resources by applying an optimized paging scheme based on a characteristic of a terminal and a network environment.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates a procedure of transferring a downlink NG1 signaling message according to an example embodiment;

FIG. 2 illustrates a procedure of transferring a downlink NG3 data packet according to an example embodiment;

FIG. 3 illustrates a procedure of performing core network (CN) assisted paging after a failure of radio access network (RAN) specific paging according to an example embodiment;

FIG. 4 illustrates a CN decision procedure for a RAN specific paging according to an example embodiment; and

FIG. 5 is a diagram illustrating a communication apparatus according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the example embodiments are described with reference to the accompanying drawings. In the respective drawings, like reference numerals refer to like elements throughout.

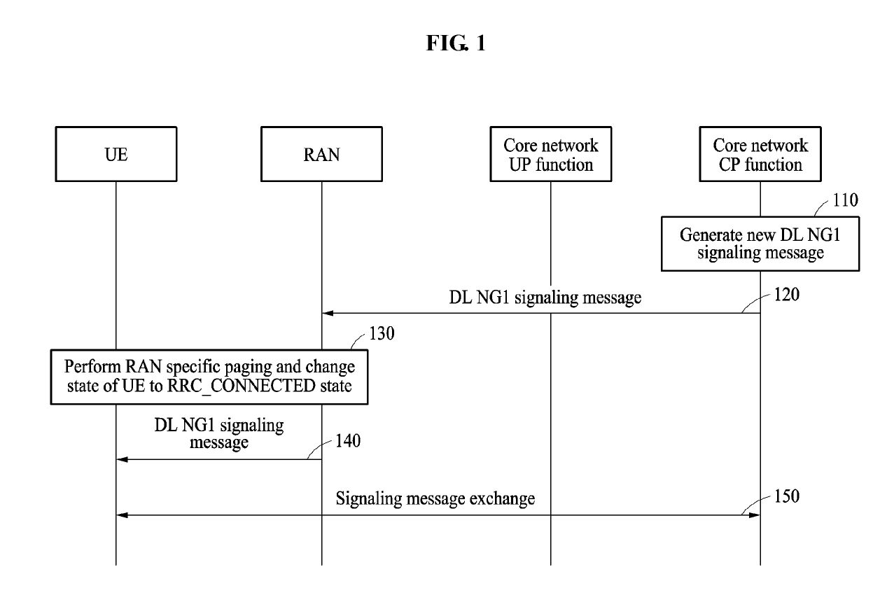

FIG. 1 illustrates a procedure of transferring a downlink NG1 signaling message according to an example embodiment.

If a user equipment (UE) is in a CN_CONNECTED state, a user plane path and a signaling path for the UE may be established between a NextGen core network (CN) and a NextGen radio access network (RAN). That is, once the UE enters the CN_CONNECTED state, NG2 and NG3 connections for the UE always exist. However, the UE may be in an RRC_INACTIVE or an RRC_IDLE. Here, RRC standards for a radio resource control. Accordingly, before an actual signaling message/data packet transfer, the UE needs to return to an RRC_CONNECTED state. However, a user plane (UP) function and a control plane (CP) function of the NextGen CN are unaware of an actual RAN state of the UE.

Here, the NextGen CN represents a 5^{th} generation (5G) core network and the NextGen RAN represents the 5G radio access network. Hereinafter, for clarity of description, they may be interchangeably used with “core network” and “RAN”, respectively. In addition, NG2 represents a reference point for a control plane between the RAN and the core network, and NG3 represents a reference point for a user plane between the RAN and the core network. Also, the CN_CONNECTED state indicates a state in which a signaling path between the UE and the core network is established and the RRC_CONNECTED state indicates a state in which the signaling path between the UE and the RAN is established. Also, the RRC_INACTIVE state indicates a state in which the signaling path and the user plane path between the UE and the RAN are inactive and the signaling path and the user plane path for the corresponding UE are maintained using connection to a most recently connected RAN in the core network. The RRC_IDLE state indicates a state in which the singling path and the user plane path between the UE and the RAN are inactive, and at the same time, the signaling path and the user plane path for the corresponding UE are inactive even in the core network.

A downlink (DL) data packet and a mobile terminated (MT) signaling message may be directly transmitted to the RAN using a UP function and a CP function of the core network. If the UE is in the RRC_INACTIVE state or the RRC_IDLE state, RAN specific paging may be triggered. In this case, the DL data packet and the MT signaling message may be buffered at the RAN.

When the UE in the RRC_INACTIVE state or the RRC_IDLE state moves to an area served by a new RAN, and in this instance, if coordination between the new RAN and an anchor RAN having NG2 and NG3 connections for the UE is supported, the anchor RAN that receives the DL data packet or the MT signaling message may cooperate with the new RAN for paging the UE. However, if the coordination between the new RAN and the anchor RAN is not supported, the new RAN needs to initiate an establishment of the NG2 and NG3 connections.

Referring to FIG. 1, once a DL signaling message for a UE in a CN_CONNECTED state is generated, a core network may transmit the DL signaling message to a RAN through NG2. If the UE is in an RRC_INACTIVE state or an RRC_IDLE state, RAN specific paging may be triggered and the DL signaling message may be buffered at the RAN until the UE returns to an RRC_CONNECTED state.

In operation 110, a core network CP function may generate a DL NG1 signaling message desired to be transmitted to the UE.

In operation 120, the core network CP function may transmit the DL NG1 signaling message to the RAN through NG2.

In operation 130, if the UE is in the RRC_INACTIVE state or the RRC_IDLE state, the RAN may buffer the DL NG1 signaling message and then perform RAN specific paging. Here, the RAN specific paging may be defined by a RAN working group (WG). Through this, the UE may return to the RRC_CONNECTED state.

In operation 140, once the UE has returned to the RRC_CONNECTED state, the RAN may transmit the buffered DL NG1 signaling message to the UE.

In operation 150, the core network CP function and the UE may exchange the DL NG1 signaling message.

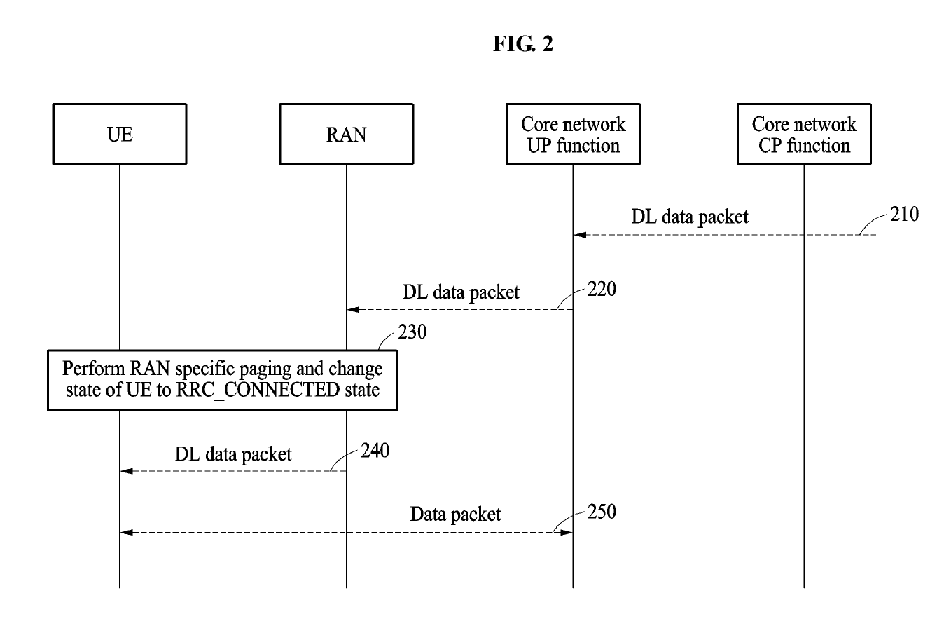

FIG. 2 illustrates a procedure of transferring a DL NG3 data packet according to an example embodiment.

Referring to FIG. 2, if a received DL data packet is present in a core network UP function, the core network UP function may directly transfer the DL data packet to a RAN. If a UE is in an RRC_INACTIVE state or an RRC_IDLE state, the RAN may buffer the DL data packet and may initiate a RAN specific paging procedure in order to make the UE return to an RRC_CONNECTED state. Once the UE returns to the RRC_CONNECTED state, the RAN may transfer the buffered DL data packet to the UE.

In operation 210, the core network UP function may receive a DL data packet.

In operation 220, the core network UP function may forward the DL data packet to a RAN through existing NG3 tunnels. The DL data packet may be buffered at the RAN. The RAN may inspect a UE RAN state. If the UE is in an RRC_CONNECTED state, operation 250 may be performed. If the UE is not in the RRC_CONNECTED state, operation 230 may be performed.

In operation 230, the RAN may perform RAN specific paging and may change a state of the UE to the RRC_CONNECTED state.

In operation 240, the RAN may transmit the DL data packet to the UE.

In operation 250, the UE and the core network UP function may start a data transfer, that is, exchange of the data packet.

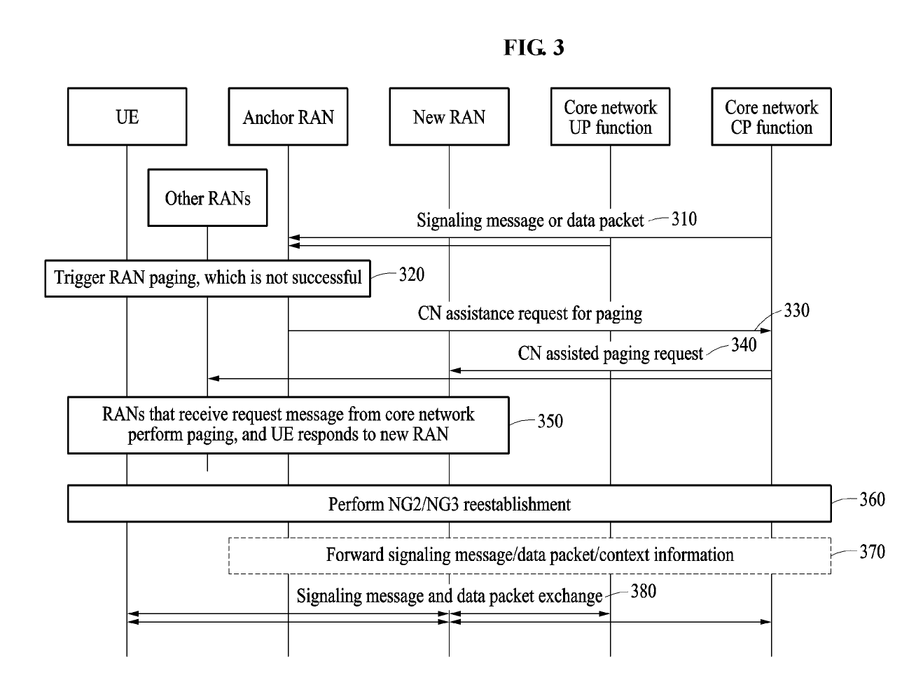

FIG. 3 illustrates a procedure of performing CN assisted paging after a failure of RAN specific paging according to an example embodiment.

Referring to FIG. 3, once RAN specific paging is applied, a signaling message or a data packet may be buffered at a RAN. If RAN paging is incapable of reaching a target UE due to an unsuccessful paging coordination within a RAN paging area or movement of UE without proper NG2/NG3 reestablishment, a packet loss may occur. A CN assisted paging retry procedure may be used to compensate a failure of the RAN specific paging. If the RAN is incapable of reaching the target UE due to the RAN specific paging, the RAN may transmit a paging request to a core network and the core network may initiate paging.

Herein, the RAN paging area may be described as follows. From a perspective of the RAN, a currently activated connection is absent and thus, the UE may not immediately perform a packet transmission and may need to transfer a paging message that requests the UE for establishing a connection. In an inactive connection state, an accurate location of the moving UE is not verified in real time. Thus, it may be difficult to specify an area to which the paging message is to be transferred. To outperform the above issues and to restrict a size of the area to which the paging message is to be transferred, a concept of the RAN paging area may be defined. Even in the inactive connection state, if the RAN is out of a set RAN paging area, the UE may operate to inform the RAN of occurrence of the above event. Accordingly, although the RAN does not verify an accurate location of the UE being in the inactive connection state, the RAN may expect that the UE stays in the allocated RAN paging area and may transmit the paging message based on the corresponding area to wake the UE.

In operation 310, the core network may generate a signaling message of NG1 or a data packet of a UP and may transmit the generated signaling message or the data packet to an anchor RAN. For example, a core network CP function may transmit the signaling message to the anchor RAN, or a core network UP function may transmit the data packet to the anchor RAN. The signaling message or the data packet may be buffered at the anchor RAN.

In operation 320, the anchor RAN may trigger RAN paging that includes a paging coordination between some RANs. Here, if the RAN paging does not successfully reach the UE, operation 330 may be performed.

In operation 330, the anchor RAN may request the core network for CN assistance for paging. That is, the anchor RAN may transmit a paging request to the core network. The paging request may further include additional information. For example, the additional information may include RAN paging area information, a last activated cell, and the like.

In operation 340, in response to the request from the anchor RAN, the core network CP function may determine a target paging area based on paging and may transmit a CN assisted paging request message to other RANs within the target paging area and a new RAN.

Herein, the target paging area may be described as follows. Since the RAN does not verify an accurate location of the UE, the RAN may appropriately determine an area on which paging retry is to be made based on an area expected in which the UE may be present and then may perform paging. Here, the area on which paging retry is to be made may be referred to as the target paging area.

In operation 350, the other RANs and the new RAN that receive a CN assisted RAN paging request from the core network CP function may perform paging. Here, the target UE that receives a paging message from the new RAN may respond to the paging request and accordingly, a state of the UE may be changed to an RRC_CONNECTED state.

For example, the other RANs and the new RAN may retrigger the RAN specific paging based on the paging request transferred in operation 330, for example, control information of the RAN, or may reuse a portion of used normal CN initiated paging.

In operation 360, NG2/NG3 connections for the UE may be reestablished between the new RAN and the core network.

In operation 370, forwarding of the signaling message and/or the data packet and/or context information from the anchor RAN to the new RAN may be performed

In operation 370, forwarding of the signaling message and/or the data packet and/or context information from the anchor RAN to the new RAN may be performed. That is, the anchor RAN may forward at least one of the signaling message, the data packet, and the context information to the new RAN.

Here, the context information may refer to any type of information associated with the corresponding UE that is received, generated, and stored at the RAN during a connection to the UE or a service to provide an appropriate service to the UE.

In operation 380, the UE and the core network may continue exchange of the signaling message and the data packet.

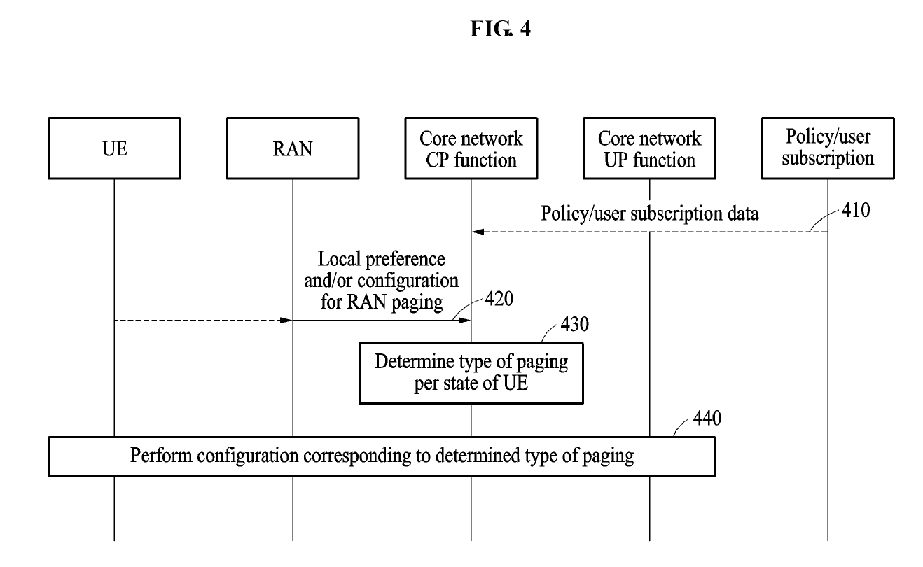

FIG. 4 illustrates a CN decision procedure for RAN specific paging according to an example embodiment.

In response to use of RAN specific paging, signaling messages and data packets are directly transmitted to and buffered at a specific RAN and coordination between RANs is required to support paging for a plurality of RANs. The RAN specific paging may be ineffective based on a network environment and a UE characteristic. For example, in a network environment in which the coordination between RANs is restricted, RAN specific paging may be ineffective due to a restricted size of a RAN paging area, a frequent area update for RAN paging, a packet loss occurring at a previous anchor RAN caused by a movement of the UE to the new RAN that does not support paging coordination with the anchor RAN, and the like.

Assistance of a core network function for RAN specific paging may mitigate some expected issues. With the assumption that both CN paging and RAN specific paging may be selectively applied to the UE in a specific state, the core network function may determine a UE and a state used to apply the RAN specific paging based on a network environment and a UE characteristic.

Hereinafter, a procedure of determining, by a core network, a paging type of a UE, that is, CN paging or RAN paging, according to an example embodiment is described with reference to FIG. 4.

Herein, a plurality of paging types may be supported with respect to a specific state or a single paging type may be supported per specific state. If only a single paging type is supported per UE state, the procedure of FIG. 4 may be applied to restrict a feasible state of the UE.

Referring to FIG. 4, in operation 410, a policy and user subscription data associated with RAN specific paging may be preconfigured or retrieved during a related procedure. For example, the procedure and the user subscription data may be retrieved and transmitted to a core network CP function.

In operation 420, a RAN may transmit information associated with RAN specific paging, for example, a local preference and/or configuration of the RAN about the RAN specific paging to the core network CP function. For example, operation 420 may be combined with a service request or an area update of the UE.

In operation 430, the core network CP function may determine a type of paging, for example, RAN specific paging or CN initiated paging, to be applied to the UE based on a policy of an operator and the received information.

In operation 440, a proper configuration for supporting the determined type of paging may be performed over the UE, the RAN, the core network CP function, and a core network UP function.

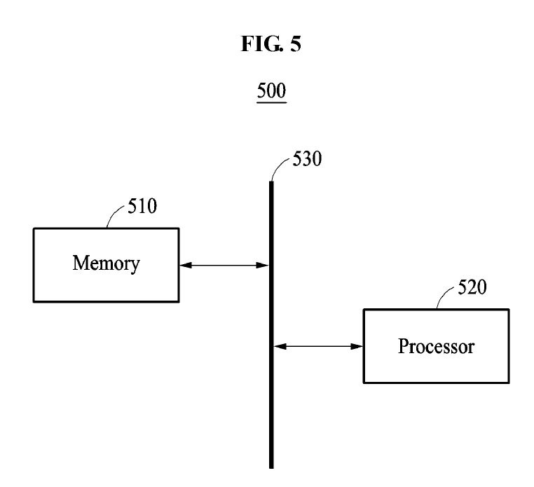

FIG. 5 is a diagram illustrating a communication apparatus according to an example embodiment.

Referring to FIG. 5, a communication apparatus 500 includes a memory 510 and a processor 520. The memory 510 and the processor 520 may communicate with each other through a bus 530.

The communication apparatus 500 refers to an apparatus that communicates with another communication apparatus in a wired or wireless manner, and may correspond to one of the UE, the RAN, and the core network, etc., described above with reference to FIGS. 1 through 4. The communication apparatus 500 may be configured as a portion of various computing devices.

The memory 510 may include computer-readable instructions. In response to an execution of an instruction stored in the memory 510 at the processor 520, the processor 520 may perform the aforementioned operations. The memory 510 may be a volatile memory or a non-volatile memory.

The processor 520 may execute instructions or programs, or may control the communication apparatus 500. The processor 520 may perform the operations described with reference to FIGS. 1 through 4.

If the communication apparatus 500 corresponds to an anchor RAN that communicates with the UE and the core network, the processor 520 receives a signaling message or a data packet for the UE from the core network and triggers paging for the UE. If paging fails, the processor 520 transmits a paging request to the core network. In response to the paging request, the core network transmits a CN assisted paging request message to a new RAN within a determined target paging area. Also, the new RAN performs paging for the UE based on the CN assisted paging request message.

The aforementioned operation may be applied to the communication apparatus 500.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication method performed by an anchor radio access network (RAN), the method comprising:
receiving a signaling message or a data packet for a user equipment (UE) from a core network;
triggering paging for the UE; and
transmitting a paging request to the core network in response to a failure of the paging,
wherein the core network is configured to transmit a core network (CN) assisted paging request message to a new RAN within a determined target paging area in response to the paging request, and
the new RAN is configured to perform the paging for the UE based on the CN assisted paging request message.

2. The method of claim 1, wherein, when the UE responds to the paging of the new RAN, NG2 and NG3 connections for the UE are reestablished between the new RAN and the core network.

3. The method of claim 1, wherein the UE is configured to return from an RRC_INACTIVE state or an RRC_IDLE state to an RRC_CONNECTED state when the UE responds to the paging of the new RAN.

4. The method of claim 1, further comprising:
forwarding at least one of the signaling message, the data packet, and context information to the new RAN when the UE responds to the paging of the new RAN.

5. The method of claim 1, wherein the paging request comprises RAN paging area information associated with the triggered paging and last activated cell information.

6. The method of claim 1, further comprising:
buffering the signaling message or the data packet in response to a failure of the triggered paging.

7. The method of claim 1, wherein the receiving of the signaling message or the data packet comprises receiving the signaling message from a control plane (CP) function of the core network or receiving the data packet from a user plane (UP) function of the core network.

8. A communication method performed by a core network, the method comprising:
transmitting a signaling message or a data packet for a user equipment (UE) to an anchor radio access network (RAN);
receiving a paging request from the anchor RAN in response to a failure of paging of the RAN for the UE; and
transmitting a core network (CN) assisted paging request message to a new RAN within a determined target paging area in response to the paging request,
wherein the new RAN is configured to perform the paging for the UE based on the CN assisted paging request message.

9. The method of claim 8, wherein, when the UE responds to the paging of the new RAN, NG2 and NG3 connections for the UE are reestablished between the new RAN and the core network.

10. The method of claim 8, wherein the UE is configured to return from an RRC_INACTIVE state or an RRC_IDLE state to an RRC_CONNECTED state when the UE responds to the paging of the new RAN.

11. The method of claim 8, wherein the anchor RAN is configured to forward at least one of the signaling message, the data packet, and context information to the new RAN when the UE responds to the paging of the new RAN.

12. The method of claim 8, wherein the paging request comprises RAN paging area information associated with the paging of the anchor RAN and last activated cell information.

13. The method of claim 8, wherein the signaling message or the data packet is buffered at the anchor RAN in response to a failure of the paging of the anchor RAN.

14. The method of claim 8, wherein the transmitting of the signaling message or the data packet comprises transmitting the signaling message to the anchor RAN from a CP function of the core network or transmitting the data packet to the anchor RAN from a UP function of the core network.

15. A communication apparatus that communicates with a user equipment (UE) and a core network, the communication apparatus comprising:
a processor; and
a memory configured to store at least one instruction executable by the processor,
wherein the processor is configured to receive a signaling message or a data packet from the core network in response to an execution of the at least one instruction at the processor, and to trigger paging for the UE, and to transmit a paging request to the core network in response to a failure of the paging,
the core network is configured to transmit a core network (CN) assisted paging request message to a new RAN within a determined target paging area in response to the paging request, and
the new RAN is configured to perform the paging for the UE based on the CN assisted paging request message.

16. The communication apparatus of claim 15, wherein, when the UE responds to the paging of the new RAN, NG2 and NG3 connections for the UE are reestablished between the new RAN and the core network.

17. The communication apparatus of claim 15, wherein the processor is configured to forward at least one of the signaling message, the data packet, and context information to the new RAN when the UE responds to the paging of the new RAN.

18. The communication apparatus of claim 15, wherein the paging request comprises RAN paging area information associated with the triggered paging and last activated cell information.

19. The communication apparatus of claim 15, wherein the processor is configured to buffer the signaling message or the data packet in response to a failure of the triggered paging.

20. The communication apparatus of claim 15, wherein the processor is configured to receive the signaling message from a CP function of the core network or to receive the data packet from a UP function of the core network.
